(19) United States
(12) Patent Application Publication
(10) Pub. No.: US 2005/0098083 A1
(43) Pub. Date: May 12, 2005

(54) FLAG LOCK

(76) Inventor: Leonid Petrenko, Sun City, AZ (US)

Correspondence Address: RICHARD D. FUERLE, 1711 W. RIVER RD., GRAND ISLAND, NY, 14072, US

(21) Appl. No.: 10/605,973

(22) Filed: Nov. 11, 2003

(51) Int. Cl. G09F 17/00

(52) U.S. Cl. 116/173

(57) ABSTRACT

A flag lock is an approximately flat plate that has a middle section between two larger end sections. A flag display has a flag having at least one eyelet with an aperture therethrough, a halyard, and a flag lock having end sections that can not pass through the apertures. Loops of the halyard pass through the apertures and over the middle sections of the flag lock.

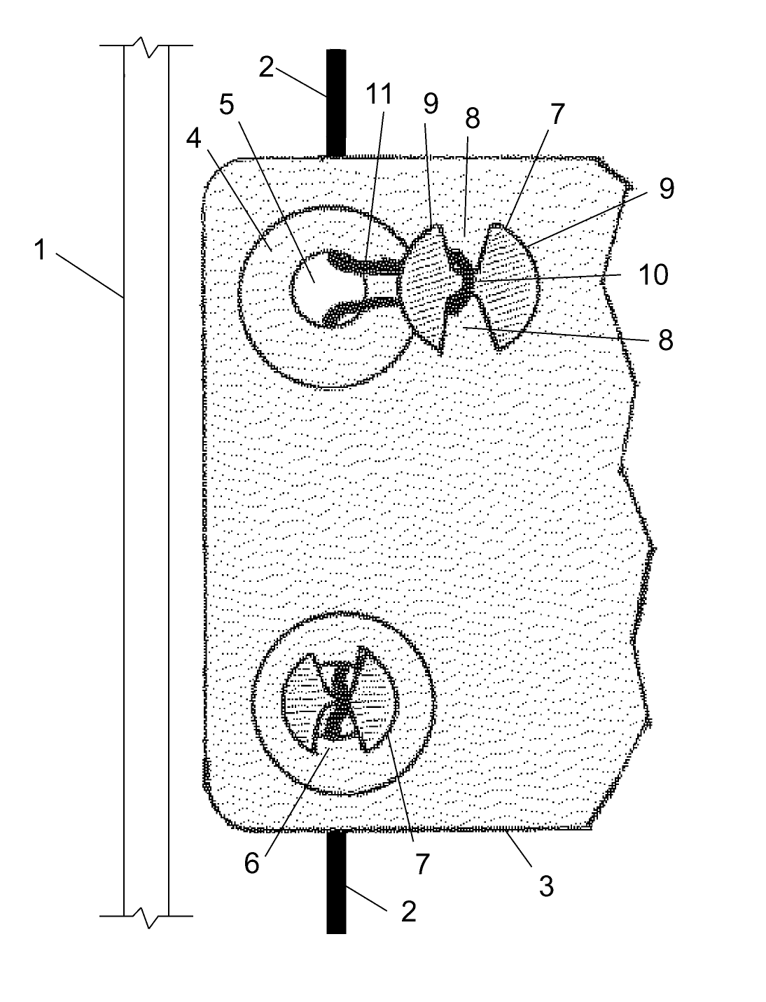

### BACKGROUND OF INVENTION

This invention relates to a flag lock for securing a flag to the halyard of a flagpole. In particular, it relates to flag lock that has two end portions and a smaller middle portion, so that loops of the halyard on a flagpole can be inserted through the aperture of the eyelets in a flag and over the middle portion of the flag lock to secure the flag.

Flags are usually secured to flagpoles by means of metal links that are attached to the halyard of the flagpole and to eyelets at one end of the flag. On windy days, these metal clips bang against the flagpole, creating loud, annoying noises. Eventually, the clips may damage the pole or the flag.

### SUMMARY OF INVENTION

I have invented a flag lock, a devise for securing a flag to the halyard of a flagpole. The flag lock of this invention is simple, easy to manufacture, and inexpensive. A flag can quickly be secured to a halyard using the flag lock of this invention and the flag lock will hold the flag securely to the halyard even in high winds.

Unlike the metal clips usually used to secure flags, the flag lock of this invention does not make loud and annoying noises by banging against the flagpole. The flag lock can be decorative and can enhance the appearance of the flag.

### BRIEF DESCRIPTION OF DRAWINGS

The accompanying drawing is a side view illustrating the flag lock of this invention securing a flag to a halyard.

### DETAILED DESCRIPTION

In the accompanying drawing, flagpole 1 is equipped with halyard 2 (a rope or cord) which usually passes over a pulley (not shown) at the top of the flagpole. There are no clips attached to the halyard, as none are needed to secure flag 3 to it. Flag 3 has two eyelets 4 at the end to be secured, one near the top of the flag and the other near the bottom. Each eyelet has an aperture 5, preferably with a flange 6 around it to strengthen the material of the flag around the aperture.

The flag lock 7 is an approximately flat plate that has opposing indentations 8 so that the two end portions 9 of the flag lock are larger than its middle portion 10. A loop 11 of halyard 2 passes through each aperture 5 and over middle portion 10 of a flag lock 7. When halyard 2 is pulled tight from the opposite side of flag 3, flag lock 7 is pressed against eyelet 4, thereby securing flag 3 to halyard 2.

The flag lock is generally flat, though it could be slightly curved or rippled or have a design embossed on it if desired. It is preferably symmetrical about a first axis that passes through two end portions 9 and middle portion 10 and is also preferably symmetrical about a second axis that is at 90° to the first axis and passes through the center of middle portion 10, as is illustrated by flag lock 7. Preferably, the peripheries of end portions 9 lie on the circumference of a circle centered at the intersection of the first and second axes, as is also illustrated by flag lock 7. Unsymmetrical designs can also be used, such as having only a single indentation on only one side. The flag lock can have any shape or design, provided a portion in the middle is narrower than its ends, so that the halyard can not slip off it. For example, it could be bone-shaped for a pirate flag, the ends could be in the shape of a family crest or a military insignia, or an inscription could be made on end portions 9, if desired. The flag lock can be made of a variety of materials, including metals, such as aluminum, brass, stainless steel, galvanized steel, and alloys, plastics such a polycarbonate, polyethylene, polypropylene, and polyvinyl chloride, laminates, wood, and other materials. It is preferably made of a rust-resistant material so that rust does not stain the flag. The flag lock can be of any color and can be plain, patterned, or have a glittered or mirror finish.

The flag lock must be large enough (or the aperture though the eyelet small enough) to prevent the flag lock from passing through the aperture in the eyelet. In addition, the aperture through the eyelet must be large enough to permit a loop of halyard to pass through it. A typical halyard may be about ¼ to about ½ inches in diameter and can be flattened somewhat, so the aperture is preferably about ⅜ to about one inch in diameter and the end portions of the flag lock are preferably about ⅛ to about ¼ inches larger than will fit through the aperture.

Most flags are made with two eyelets at one end, but the invention can be used with flags that have only a single eyelet or that have more than two eyelets. The flange of these flags can be made of thread, metal, or other material. If a flag does not have eyelets, apertures can be punched or cut out of the flag and flanges applied by glue, using a rivet, sewing, or other means.

While the flagpole will usually be vertical, the flag lock of this invention can also be used with non-vertical flagpoles, such as those that extend at an angle from homes and buildings.

1. A flag lock comprising a flat plate that has a middle section between two larger end sections.

2. A flag lock according to claim 1 that is symmetrical about an axis that passes through said middle section and said end sections.

3. A flag lock according to claim 1 that is symmetrical about a first axis that passes through the center of said middle section and is at 90° to a second axis that passes through the center of said end sections.

4. A flag lock according to claim 3 wherein said flag lock comprises a flat plate in the shape of a circle having opposing notches removed, where the sides of said notches extend in a line from the periphery of said circle inwardly towards the center of said circle.

5. A flag lock according to claim 1 made of plastic.

6. A flag lock according to claim 1 made of a rust-resistant metal.

7. A method of displaying from the halyard of a flagpole a flag having at least one eyelet with an aperture therethrough, comprising passing a loop of said halyard through said aperture and over the middle section of a flag lock according to claim 1, where the end section of said flag lock can not pass through said aperture.

8. A flag display comprising
(A) a flag having at least one eyelet with an aperture therethrough;
(B) a flag lock according to claim 1 that has end sections that can not pass through said aperture; and
(C) a halyard, a loop of which passes through said aperture and over the middle section of said flag lock.

9. A flag display according to claim 8 wherein said flag lock is symmetrical about a first axis that passes through the center of said middle section and said end sections and that is symmetrical about a second axis at 90° to said first axis that passes through the center of said middle section.

10. A flag display according to claim 9 wherein the periphery of said end sections lies on the circumference of a circle centered at the intersection of said first axis and said second axis.

11. A flag display according to claim 8 wherein said flag lock is made of plastic.

12. A flag display according to claim 8 wherein said flag lock is made of a rust-resistant metal.

13. A flag display according to claim 8 wherein said apertures are about ⅜ to about one inch in diameter and the end portions of said flag lock are about ⅛ to about ¼ inches larger than will fit through said apertures.

14. A flag lock comprising a flat plate that comprises a middle section between two larger end sections, where said flag lock (1) is symmetrical about a first axis that passes through said middle section and said end sections and (2) is symmetrical about a second axis at 90° to said first axis that passes through the center of said middle section.

15. A flag lock according to claim 14 wherein the periphery of said end sections lies on the circumference of a circle centered at the intersection of said first axis and said second axis.

16. A flag lock according to claim 14 made of plastic.

17. A flag display according to claim 14 made of a rust-resistant metal.

18. A flag display comprising
(A) a flag having at one end two eyelets each with an aperture therethrough;
(B) a flag lock according to claim 14 for each eyelet, said flag locks having end sections that can not pass through said apertures; and
(C) a halyard, a loop of which passes through said aperture and over the middle section of said flag lock.

19. A flag lock comprising a flat rust-resistant plate in the shape of a circle having opposing notches removed, where the sides of said notches extend in a line from the periphery of said circle inwardly towards the center of said circle.

20. A flag display comprising
(A) a flag having at one end two eyelets each with an aperture therethrough;
(B) a flag lock according to claim 19 for each eyelet, said flag locks having end sections that can not pass through said apertures; and
(C) a halyard, a loop of which passes through said aperture and over the middle section of said flag lock.
